(19) United States
(12) Patent Application Publication
(10) Pub. No.: US 2026/0250053 A1
(43) Pub. Date: Aug. 27, 2026

(54) MULTILAYER FILM WITH DIFFERENT ADHESION ZONES FOR SEALING A CAPSULE FOR MAKING BEVERAGES

(71) Applicant: GUALA PACK S.P.A., Castellazzo Bormida (Alessandria) (IT)

(72) Inventors: Fabio TANSINI, Castellazzo Bormida (Alessandria) (IT); Gino TANSINI, Castellazzo Bormida (Alessandria) (IT); Lorenzo ZAMIRRI, Castellazzo Bormida (Alessandria) (IT); Riccardo ZAMMORI, Castellazzo Bormida (Alessandria) (IT)

(21) Appl. No.: 18/995,473

(22) PCT Filed: Jul. 20, 2023
(86) PCT No.: PCT/IB2023/057407

§ 371 Date: Jan. 16, 2025

(30) Foreign Application Priority Data
Jul. 29, 2022 (IT) 102022000016101

(51) Int. Cl. B65D 65/40; A47J 31/36; B32B 3/26; B32B 7/06; B32B 7/12; B32B 27/10; B32B 27/36; B65D 65/46; B65D 85/804

(52) U.S. Cl. CPC B65D 65/40; A47J 31/36; B32B 3/266; B32B 7/06; B32B 7/12; B32B 27/10; B32B 27/36; B65D 65/466; B65D 85/8061; B32B 2250/03; B32B 2255/10; B32B 2255/205; B32B 2307/7163; B32B 2307/7246; B32B 2307/737; B32B 2439/70

(57) ABSTRACT

A multilayer film for sealing a capsule for making beverages has an outer layer with barrier properties, an inner layer intended to come into contact with the capsule the to be sealed, the inner layer being a micro-perforated film provided with a plurality of micro-holes, and an intermediate layer between the outer layer and the inner layer. The intermediate layer is partially peelable from the inner layer. Innovatively, the multilayer film has zones with differing adhesion levels between the layers that lead to an improved perforation opening.

The object of the present invention is an easily perforated multilayer film, for the packaging of foods and beverages, and in particular for implementing the lid of a capsule for making infusion or soluble beverages (for example, coffee, tea and soluble herbal teas). The object of the invention is also a capsule having an external lid (top lid) made from said film, and a related extraction method.

In the sector, capsules are known for the packaging of concentrated products (e. g., in the form of powder, granules, leaves) in predetermined, single-use doses, for the impromptu preparation of beverages (such as tea, coffee, herbal teas, milk, chocolate, etc.) by means of the introduction, into said capsule, of a fluid under pressure (mostly hot water). Said flow of hot water, delivered by an extraction machine, passes through the essence to be infused or dissolved contained inside the capsule, which results in the impromptu preparation of the beverage.

Different types of automatic or semi-automatic beverage preparation machines are known in the industry. A first type of machine envisages the perforation of the capsule on both sides, in order to allow the pressurized fluid to be injected into the cup on one side, and the beverage to flow out from the opposite side. This first type of machine is intended for capsules comprising a cup that is closed on both sides, respectively by a bottom and a lid (top lid). In such applications, the high temperature and high pressure extracted water enters the base of the capsule and emerges from the lid which opens in perforating itself at various points against an appropriate element of the exaction machine. The extraction device of the dispensing machine in fact comprises a plurality of piercing elements that, wherein the pressure of the liquid inside the capsule increases, engage with the lid and perforate it at a plurality of different zones. The final product may flow into the final container through the perforations produced by the extraction device of the dispensing machine. It follows that for a good dispensing result, the piercing elements should correctly perforate the lid element and the resulting perforations should remain open during the entire delivery of the final product.

The structure the lid, which is generally multilayer, must therefore firstly allow for the correct opening and subsequently the correct emergence of the product. In the case of external lids, or top lids, the multilayer is applied to the edge of the capsule body full of foodstuff product (in powder of granular form) by means of heat welding or similar techniques. Those lids that are actually on the market have standard multilayer structures, for example PET-PETALOX-PP, PET-PET-PP, PET-PET-PE or similar. Generally, in cases wherein it is also necessary to filter the beverage being dispensed from the capsule, the structure consists of three different materials: a first barrier layer, a second filtering layer and a non-compostable adhesive in between the two.

Such structures have some disadvantages. Above all, these are non-recyclable multi-material structures resulting in environmental impacts. Furthermore, such structures require the adoption of adhesives in order to join together the different layers of material that constitute the multilayer, according to current regulations they are not suitable for coming into contact with foodstuffs. Although with the capsule intact, there is no direct contact between the adhesive and the powder contained within the capsule body, some form of contamination at the extraction stage cannot a priori be ruled out insofar as the high temperature and high pressure extracted water, in passing through the multilayer structure of the lid, may be contaminated by substances/additives that are present within the formulation of such adhesives.

Lids have recently been introduced onto the market that are made from a compostable material, which however, only partially obviate the above mentioned disadvantages. In fact, such multilayer structures nonetheless include the use of adhesives and do not resolve the problem of possible contamination of the beverage during the extraction step. Furthermore, common compostable materials often do not have degrees of brittleness that are suitable for the application and risk compromising the correct opening of the capsule.

The choice of film used to make the lid of the capsule is particularly difficult insofar it has to be easily perforable such a film, easily attachable to the flange edge of the capsule, for example by means of welding, to ensure the airtightness of the cavity closure, and in some cases to be made of a compostable material.

In the case of known films, the multilayer structure sometimes comprises at least one non-woven fabric (TNT) or similar layer having a filter function that is joined, by means of an adhesive, to a carrier layer. It may be noted how structures using TNT or a filter often have dispensing problems. Some deliveries may be interrupted after a few seconds without completion of the delivery and the dispensing machine may also become blocked. The reason for this has been identified by the fact that, after the first perforations, the pressure of the fluid within the capsule reduces and such a reduced pressure does not allow the multilayer film to perforate any further. Under these conditions the TNT or filter layer, stressed by the pressure inside the capsule, tends to insert itself into the perforations generated in the multilayer film and to obstruct them, thereby interrupting the delivery of the final product. The delivery of the final product is therefore compromised and contemporaneously a loss of liquid is observed from the housing whereinto the capsule is inserted.

Known structures comprising a filter and/or a TNT that is joined to the layer immediately above by means of lamination using adhesives have numerous disadvantages:
the pores of the filter and/or TNT are meshes that, under the momentum of the high-pressure liquid, may become flooded thereby allowing the foodstuff product in powder form (for example coffee) to infiltrate into the meshes themselves, effectively clogging the system and affecting the proper functioning thereof and thus preventing proper delivery;
the filter and/or the TNT non-woven fabric, also have, in general, the function of a capsule welding layer, and therefore tend to impregnate the beverage, such as coffee, leading the entire system to deliver incorrectly;
the filter and/or the TNT non-woven fabric is a non-uniform porous material, wherein the pores have a totally random distribution. When the same also represent the layer that welds against the capsule, this non-uniform distribution of the pores renders the weld area at the edge of the capsule body uneven, thereby leading to uneven weldability profiles;
the adhesives used to join the TNT non-woven fabric and/or the filter to the upper layer do not have thermal-welding properties and in passing through the pores of the filter may create non-welded zones at the edge of the capsule body thereby compromising the correct functioning of the extraction system that may also result in non-delivery;
those adhesives that are actually on the market, both compostable and non-compostable, both solvent and water-based and solvent-less, are often not suitable for (direct) food contact as according to the main national and supranational regulations in force. Even though it is the case that during the filling and closure step the contact between the powder material and the potentially harmful substances contained within the adhesives is minimal, if any, it is however not possible a priori to rule out any contamination as a result of the passage of hot, high-pressure water through the filter meshes and therefore also through the adhesive present within the pores of the filter, especially insofar as it is known that such high pressure and temperature conditions favor the extraction of any substances.

The object of this invention is to provide a film for making the lid of a capsule that solves the problems of the prior art while taking into account the needs of the industry.

In particular, the object of the present invention is that of supplying a multilayer film for the manufacture of the lid of a capsule that has an aperture for improved perforations.

The object of the present invention is also that of supplying a multilayer film for the manufacture of a lid that may be free of adhesives.

The object of the present invention is also that of supplying a multilayer film for the manufacture of a lid that may be compostable.

The object of the present invention is also that of supplying a capsule that ensures the correct implementation of the perforations and also good quality beverage extraction.

This object is achieved by a film according to claim 1, by a capsule according to claim 15 and an extraction method according to claim 17. The dependent claims describe preferred embodiments of the invention.

The features and the advantages of the invention will appear more clearly from the following description, made by way of an indicative and non-limiting example with reference to the accompanying figures, wherein:

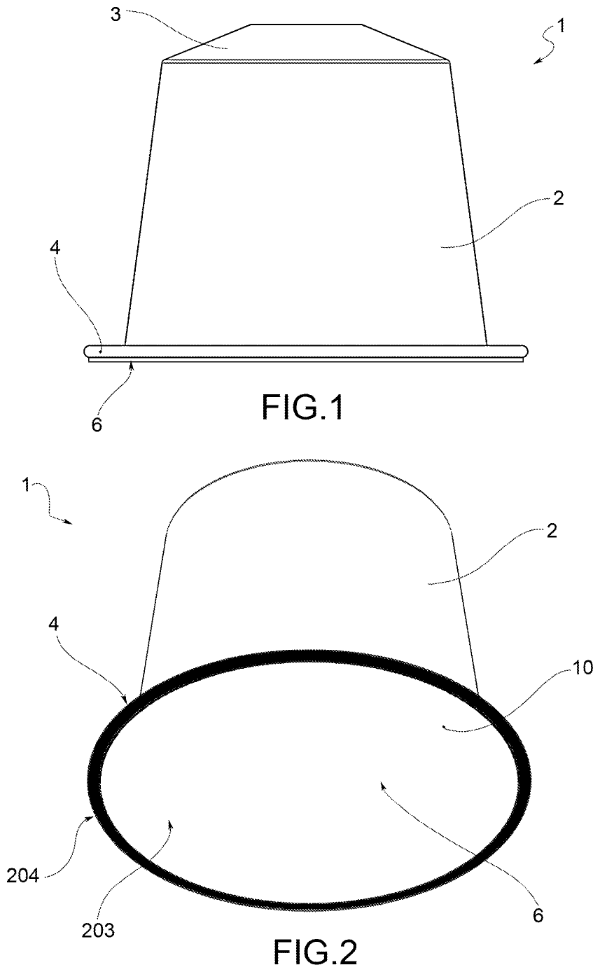

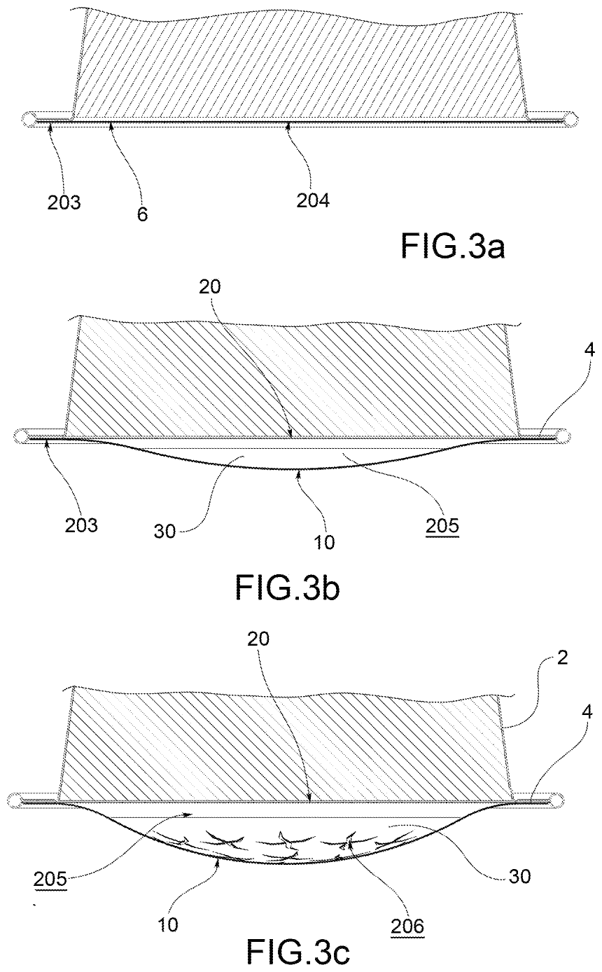

FIGS. 1 and 2 show, respectively, a lateral view and an axonometric view of a capsule for making infusion or soluble beverages, provided with a lid according to the present invention;
the Figures from 3a to 3c show, in a lateral view, the steps of opening the capsule, and in particular the delamination of the lid during the extraction of the beverage;
the Figures from 4a to 4c show, in an axonometric view, the steps of opening the capsule, and in particular the delamination of the lid during the extraction of the beverage;
the Figures from 5 to 8 show embodiments of a multilayer laminated film for a compostable version of a lid according to the present invention;

FIGS. 9 and 10 show embodiments of a multilayer laminated film for a non-compostable version of a lid according to the present invention;

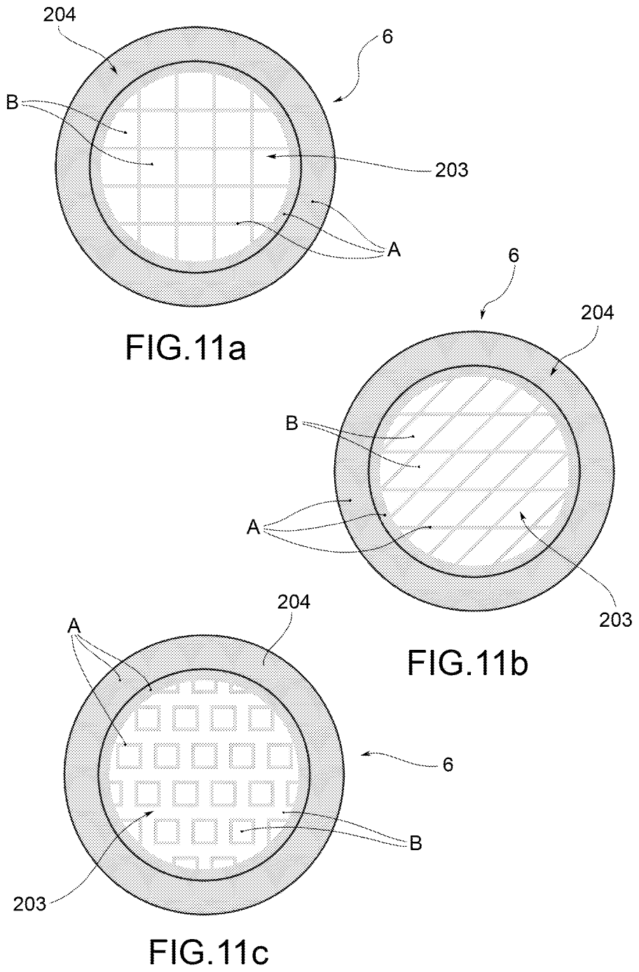

FIGS. 11a, 11b and 11c show example of a lid with differing levels of adhesion between the micro-perforated inner layer and the intermediate layer.

The object of the present innovation is a multilayer laminate for the implementation of the lid 6 of a capsule for coffee or beverages, having adhesions that vary between two or more layers of the laminate itself. The term adhesion refers to the force necessary to separate, without tearing, two layers of differing materials that are joined together as a laminate.

With reference to the attached figures, a capsule for the preparation of infusion or soluble beverages is shown, indicated by the reference number 1.

The capsule 1 comprises a cup-shaped body 2 suitable for defining an inner volume V wherein at least one substance to be infused or dissolved is typically contained in powder or granular form.

The cup-shaped body 2 is provided on one side, with a bottom 3 and, on the opposite side, with an opening defined by an externally projecting edge 4. The capsule 1 comprises a lid 6 fastened to the edge 4 for sealing the capsule. In one usage example of the capsule, the high temperature and high pressure extracted water enters the base 3 of the cup-shaped body 2 and emerges from the lid 6 which opens in perforating itself at various points against an appropriate element of the exaction machine.

The film is a multilayer laminate, comprising at least three layers, and in particular one outer layer 10, one inner layer 20 intended to make contact with the cup in order to seal the capsule 1, and an intermediate layer 30.

The outer layer 10 is a gas, light and vapor barrier layer. For example, it has oxygen, humidity, water, fats, aromas and light barrier properties. Such properties may alternatively derive from processing that does not include surface treatments, or else from surface treatments, such as for example metallization.

The outer layer 10 is a brittle film, that is to say with appropriate brittleness characteristics, capable of appropriately fracturing itself against the perforating elements of the dispensing machine. The brittleness is to be understood,, for example, as the least possible elongation following breakage and perforation on the part of the perforating elements of the dispensing machine.

In one embodiment, the lid 10 is made of a compostable material. For example, the outer layer 10 is made of paper, or else from regenerated cellulose.

The outer layer 10 preferably has a uniform thickness of between 10 μm and 90 μm.

The outer layer 10 has a weight that is variable between 5 and 120 gsm, more preferably between 15 and 90 gsm.

In one embodiment the outer layer 10 is made of paper. Preferably, the paper has barrier properties deriving solely from the dense adhesion of the paper microfibers and deriving from the depositing of chemical lacquers or coating or metallization treatments. Furthermore, the paper is not comparable to a vegetable parchment that is to say it does not include the use of sulfuric acid and/or zinc chloride.

In one embodiment, the barrier properties of the paper may be incremented by means of appropriate surface processes (such as, for example, metallization) that do not affect the compostability of the paper itself according to current standards.

In one embodiment the outer layer 10 is made of regenerated cellulose with barrier properties. The regenerated cellulose comprises a cellulose based central layer and two external coverings, for example based upon PVDC, PVOH lacquer, silicon or aluminum oxides or a metallization based upon metallic aluminum. The regenerated cellulose outer layer 10 has a reduced thickness and sufficient stiffness to be easily breakable when exposed to working pressures or to those perforating elements that exist in beverage extraction machines.

In one further exemplary embodiment, the outer layer 10 is not compostable.

In such an example, the outer layer 10 is made of poly-ethylene terephthalate PET that has been weakened and metallized in order to confer barrier properties thereto.

In one further exemplary embodiment, the outer layer 10 is an aluminum film.

The inner layer 20 is a micro-perforated film. In other words, the inner layer 20 is provided with a plurality of through holes 201.

Preferably, the texture of the micro-holes of the inner layer 20 is optimized so as to ensure the best lid properties. Preferably, the diameter of the micro-holes 201 is between 0.1 mm and 1.0 mm, and even more preferably between 0.3 and 0.8 mm. Preferably, said density of micro-holes is between 5 and 25 micro-holes/cm2 , even more preferably between 8 and 20 micro-holes/cm2.

The micro-perforated inner layer 20 is made of a plastic material that is chemically similar and sealable to the edge 4 of the cup-shaped body 2 of the capsule.

In one exemplary embodiment, the micro-perforated inner layer 20 is made of a compostable material, for example poly-lactic acid PLA. With the aim of improving the adhesion with the intermediate layer 30, the micro-perforated inner layer 20 has a surface coating of the aluminum oxide or silicon oxide type.

The inner layer 20 preferably has gas, light and vapor barrier properties. For example, it has oxygen, humidity, water, fats, aromas and light barrier properties. Such properties may alternatively derive from processing that does not include surface treatments, or else from surface treatments, such as for example metallization.

The intermediate layer 30 is made of a polymer material and is applied in a particular manner to the inner layer 20 in such a way that said inner layer 20 is at least partially incorporated into the intermediate layer 30. The intermediate layer 30 is cast, whilst still hot, onto micro-perforated inner layer 20, in such a way as to fill the micro-holes 201.

The intermediate layer 30 is made of a plastic material that is chemically similar and sealable to the edge 4 of the cup-shaped body 2 of the capsule. Preferably, the intermediate layer 30 is made of a plastic material that is chemically similar and sealable also to the outer layer 10 and to the inner layer 20.

In one exemplary embodiment, the intermediate layer 30 is a compostable biopolymer that is extruded and loaded with additives which promote the peelability thereof and that is possibly loaded with polymers that promote the brittleness thereof. For example, those polymers that are suitable for constituting the intermediate layer 30 are poly-butylene-succinate (PBS), poly-lactic acid (PLA), poly-butylene-adipate-terephthalate (PBAT) or the compounds/blends thereof, and any other polymers of plant origin.

In one further embodiment, the outer layer 30 is not compostable. In such an example, it is either poly-ethylene (PE) or poly-propylene (PP) or a similar polymer that is extruded and loaded with additives that promote the peelability thereof and is possibly loaded with polymers that promote the brittleness thereof. Suitable additives for ensuring peelability include the same poly-ethylene (PE) and poly-propylene (PP), and more generally other poly-olefins (PO) such as poly-butadiene (PB).

The aim of such additives is that of making it possible to peel the polymer away from the inner layer 20 under certain conditions of temperature and pressure within the capsule 1, prior to dispensing or when dispensing the beverage

In one exemplary embodiment, the intermediate layer 30 is an adhesive. In such an exemplary embodiment it is possible to obtain the formation of one or more thrust chambers taking advantage of in-register lamination, that is, spreading the adhesive only in certain areas of the laminate, thereby creating zones of variable adhesion by means of variable geometry configurations. The zones of variable adhesion represented, for example, in FIGS. 11a, 11b and 11c, wherein the lid 6 has a grid with a high level of adhesion A (obtained in adding the adhesive) at the central zone 203, which defines a plurality of low adhesion level zones B (without adhesive) between the micro-perforated inner layer 20 and the intermediate layer 30. Alternatively, zones of variable adhesion may be obtained by means of the depositing of significantly varying values of weight, in such a way as to create a peelable effect. The zones of variable adhesion represented, for example, in FIGS. 11a, 11b and 11c, wherein the lid 6 has a grid with a high level of adhesion A (obtained in adding a greater quantity of adhesive) at the central zone 203, which defines a plurality of low adhesion level zones B (with a lower quantity of adhesive) between the micro-perforated inner layer 20 and the intermediate layer 30.

The adhesion between the micro-perforated inner layer 20 and the intermediate layer 30 is sufficiently high to maintain the laminated multilayer film joined during the actual lamination step and during the subsequent steps of transportation and handling up and until the production of the capsule. At the same time, such adhesion is sufficiently low to allow for delamination between the micro-perforated inner layer 20 and the intermediate layer 30 under certain conditions of temperature and pressure within the cup-shaped body 2, before the delivery step or else during the delivery step. Following the lamination step, such adhesion is low and values of between 0.25 and 5.00 N/15 mm, preferentially between 0.50 and 1.50 N/15 mm.

The laminated multilayer film therefore exhibits, for all intents and purposes, features of peelability between the micro-perforated inner layer 20 and the intermediate layer 30.

During the capsule 1 packaging step, and in particular during the step of sealing the lid 6, implemented with the laminated multilayer film according to the present invention, onto the edge 4 of the capsule 1, as a result of the action of heat sources, and exploiting the mutual chemical affinity thereof, the adhesion between the micro-perforated inner layer 20 and the intermediate layer 30 is increased only in some zones of the lid, for example by means of the use of appropriate sealing bars. Following such a sealing action, this adhesion is elevated and has values that are greater than 1.00 N/15 mm, preferentially greater than 5.00 N/15 mm, only within those zones that are subject to sealing, whereupon the sealing bars have acted.

The lid 6 therefore exhibits, for all intents and purposes, features of peelability between the micro-perforated inner layer 20 and the intermediate layer 30. In particular, the lid 6 has a high level of adhesion (indicated in gray and with the reference A in the figures) at least at the outer periphery 204 corresponding to the welding zone with an edge 4 of the cup-shaped body 2 and a low level of adhesion (indicated in white with the reference B in the figures) in the remaining part of the lid 6, for example in the central zone 203.

In other words, the lid 6 has at least one low level of adhesion zone between the micro-perforated inner layer 20 and the intermediate layer 30, and therefore a delamination zone at the central zone 203.

In a further exemplary embodiment the lid 6 has areas with a high level of adhesion between the micro-perforated inner layer 20 and the intermediate layer 30, and also at the central zone 203. The areas at a high level of adhesion are for example a point, preferably a plurality of points, at a high level of adhesion, obtained by means of spot welds between the micro-perforated inner layer 20 and the intermediate layer 30.

In a further exemplary embodiment, shown in FIGS. 11a, 11b, and 11c, the lid 6 has a grid with a high level of adhesion A at the central zone 203, which defines a plurality of low adhesion level zones B between the micro-perforated inner layer 20 and the intermediate layer 30. Said grid at a high level of adhesion may be obtained by means of sealing bars.

Once the cup-shaped body 2 has been filled with a foodstuff substance, the lid 6 is welded to the edge 4 of the cup-shaped body 2 in order to seal the capsule 1 thereabove. Frequently, some days after the packaging, during the storage step of the capsule 1 that has been filled with a foodstuff substance such as coffee in powder or granular form, so-called outgassing occurs. This is a natural phenomenon wherein the coffee powder loses and releases gases, principally carbon dioxide, that form within the foodstuff substance during roasting. The gas produced by the outgassing causes the pressure within the cup-shaped body 2 to increase and the action of such pressure causes separation, that is to say delamination, between the inner layer 20 and the intermediate layer 30 within the low adhesion zones only. At least one thrust chamber 205 is thus formed between the inner layer 20 and the intermediate layer 30. During the capsule 1 extraction step in the extraction machine, the extraction liquid accumulates within the thrust chamber 205 thereby generating a push towards the outside of the remaining layers of the laminated multilayer film, at least of the outer layer 10, layers that are pushed so as to tear against the piercing elements of the dispensing machine. A plurality of beverage outlet openings 206 is thus easily and correctly formed within the outer layer 10. Such a solution ensures the correct opening of the capsule 1 and the correct delivery of the beverage.

In the case wherein outgassing is observed, for example for foodstuff substances that are not subject to a loss of gas, or else in the case that the outgassing may be insufficient to generate pressure for delamination within the cup-shaped body 2, the separation between the inner layer 20 and the intermediate layer 30 within those zones that are at low pressure nonetheless occurs during the initial capsule 1 extraction step.

During the capsule 1 extraction step in the extraction machine, the action of the pressure of the hot liquid within the cup-shaped body 2 causes separation, that is to say delamination, between the inner layer 20 and the intermediate layer 30 within the low adhesion zones only. Given that the perforation of the lid 6, and in particular the tearing thereof against the appropriate piercing elements of the dispensing machine, occurs in a moment in time after the entry of the extraction liquid through the base 4 of the capsule 1, at least one thrust chamber 205 is formed between the inner layer 20 and the intermediate layer 30. In a fraction of a second the extraction liquid accumulates within such a thrust chamber 205 thereby generating a push towards the outside of the remaining layers of the laminated multilayer film, at least of the outer layer 10, layers that are pushed so as to tear against the piercing elements of the dispensing machine. A plurality of beverage outlet openings 206 is thus easily and correctly formed within the outer layer 10. Such a solution ensures the correct opening of the capsule 1 and the correct delivery of the beverage. By virtue of the presence of the micro-perforated inner layer 20, interposed between the foodstuff substance contained within the cup-shaped body 2 and the outer layer 10, the final product passes through the micro-perforated layer before intercepting the outer layer 10 and the pressure of the final product is thus evenly distributed over the outer layer 10 ensuring that it perfuses evenly. Furthermore, by virtue of fact that the micro-perforated inner layer 20 separates itself from the outer layer 10, the perforations within such outer layer 10 are not blocked in any way.

The high level of adhesion zones are on the other hand not affected by the delamination and within such high level of adhesion zones the inner layer 20 and the intermediate layer 30 remain welded together. In fact, the polymer that is used to make the intermediate layer 30 is cast, whilst still hot, onto the micro-perforated inner layer 20, it penetrates through the micro-holes 201 and fills them, and the inner layer 20 is at least partially incorporated within the biopolymer of the intermediate layer 30. This intermediate layer 30 therefore forms a welding material spacing that is ideal for ensuring the weldability of the lid 6 to the flange, or edge 4, of the cup-shaped body 2 of the capsule 1.

Furthermore, delamination does not occur between the intermediate layer 30 and the outer layer which remain welded together.

In one exemplary embodiment the polymer material of the intermediate layer 30 is loaded, that is, supplemented, with appropriate embrittlement additives that render it fit for purpose. For example, amongst the additives used for the purpose, there may be included talc, calcium carbonate, and/or other compostable biopolymers such as poly-hydroxybutyrate (PHB), poly-hydroxyvalerate (PHV), or, more generically, other biopolymers belonging to the poly-hydroxyalkanoate (PHA) class. Such additives are appropriately compatible with the biopolymer matrix. The object of such additives is that of rendering the polymer brittle to the right degree depending upon the piercing system that is included in the dispensing machine. All of the constituents of such a layer, and therefore the polymer matrix with the addition of embrittlement additives, are found to be suitable for coming into contact with foodstuffs. Preferably, the final weight of such a layer, composed of a biopolymer and additives, is between 4 g/m2 and 40 g/m2, preferably between 10 g/m2 and 25 g/m2.

In some particular cases and for particular requirements the multilayer laminated film comprises a further outer covering 40.

For example, the further outer covering 40 comprises a further outer layer 41 with features that are similar or analogous to the outer layer 10 whereto it is joined by means of a cast polymer, or alternatively adhesive, joining layer 42. The further outer covering 40 may be compostable.

In one exemplary embodiment the further outer covering 40 comprises, for example, a fracturable paper film that is devoid of barrier properties and that is joined by means of an extruded compostable biopolymer (that may be loaded with embrittlement additives) or else by means of an adhesive, to the outer layer 10.

In a further example, the further coating 40 comprises a weakened non-metallized poly-ethylene terephthalate film PET, joined by means of an extruded polymer layer, for example poly-ethylene-based PE or poly-propylene-based PP, or by means of an adhesive, to the inner layer 10.

According to the type of filler product, for example for particularly fine coffee powder, the further outer covering 40 comprises a filtering element 43, for example filter paper or (TNT) non-woven fabric, joined by means of an extruded polymer layer or else by and adhesive to the outer layer 10.

In one exemplary embodiment the further outer covering 40 is composed of a TNT non-woven fabric that is joined by means of an extruded compostable biopolymer or else by means of an adhesive, to the outer layer 10.

Examples of the manufacture of the multilayer film that forms the lid 6 in accordance with the present invention will now be described. It should be noted that these are laminated multilayer structures.

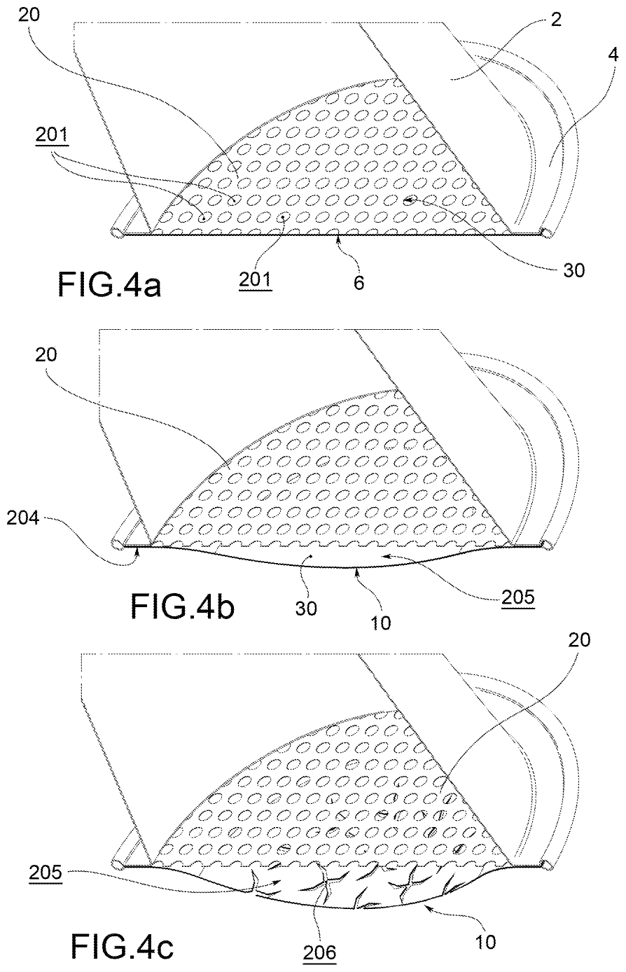

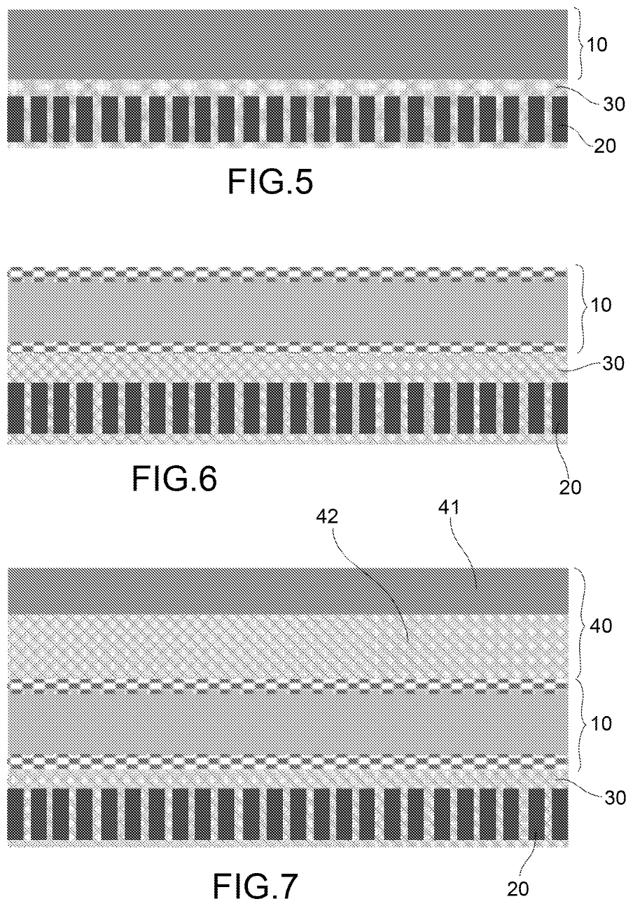

The examples of FIGS. 5 to 8 refer to compostable structures.

FIG 5. shows a triple compostable structure comprising:
outer side (that is to say the outer layer 10): fracturable paper, possibly with barrier properties not deriving from depositing and/or metallization;
inner side: compostable PLA micro-perforated inner layer 20 at least partially immersed in the intermediate layer 30 made of a polymer extruded, cast and loaded with additives that give it peelable properties and possibly embrittlement additives.

FIG. 6 Shows a Triple Compostable Structure comprising:
outer side (that is to say the outer layer 10): regenerated cellulose with barrier properties;
inner side: compostable PLA micro-perforated inner layer 20 at least partially immersed in the intermediate layer 30 made of a polymer extruded, cast and loaded with additives that give it peelable properties and possibly embrittlement additives.

FIG. 7 shows a complex compostable structure, corresponding to the structure f FIG. 6 with the addition if further outer coverings 40:
outer layer: further outer covering 40 composed of a non-barrier paper 41 joined to an extruded polymer 42 that allows for the permanent adhesion thereof to the outer layer 10 made of regenerated cellulose with barrier properties;
inner side: compostable PLA micro-perforated inner layer 20 at least partially immersed in the intermediate layer 30 made of a polymer extruded, cast and loaded with additives that give it peelable properties and possibly embrittlement additives.

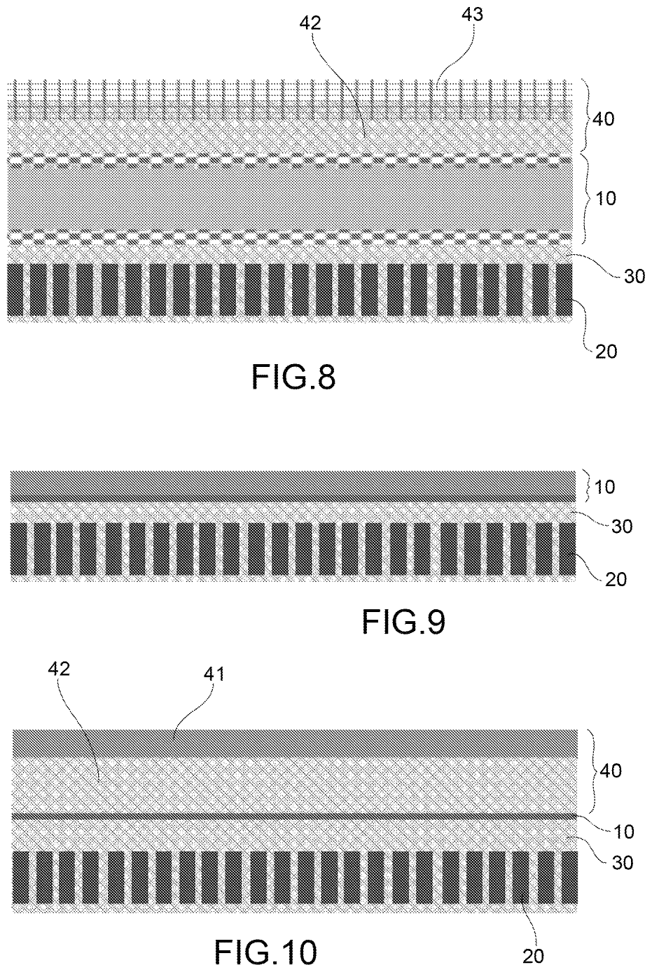

FIG. 8 shows a complex compostable structure, corresponding to the structure of FIG. 6 with the addition if further outer coverings 40:
outer layer: further outer covering 40 composed of a filter element 43, for example filter paper or else a non-woven fabric joined to an extruded polymer 42 that allows for the permanent adhesion thereof to the outer layer 10 made of regenerated cellulose with barrier properties;
inner side: compostable PLA micro-perforated inner layer 20 at least partially immersed in the intermediate layer 30 made of a polymer extruded, cast and loaded with additives that give it peelable properties and possibly embrittlement additives.

Further exemplary embodiments of compostable laminates described from the most outer layer to the most inner layer (welding):
fracturable paper film with barrier properties not deriving from the depositing of chemical lacquers such as PVDC, PVOH, EVOH, aluminum oxide, silicon oxide and/or metallization; extruded compostable biopolymer loaded with additives which promote the peelability thereof and possibly others that increase the brittleness thereof ; extruded polymer film or PLA-type, brittle cast or bubble, suitably micro-perforated and welded to the capsule body. Such a micro-perforated layer may have, with the aim of improving the adhesion thereof with the layer wherein it is immersed and the barrier properties of the laminate as a whole, a surface coating such as aluminum oxide or silicon oxide;
fracturable regenerated cellulose film with barrier properties deriving from the depositing of chemical lacquers such as PVDC, PVOH, EVOH, aluminum oxide, silicon oxide and/or metallization; extruded compostable biopolymer loaded with additives which promote the peelability thereof and possibly others that increase the brittleness thereof; extruded polymer film or PLA-type, brittle cast or bubble, suitably micro-perforated and welded to the capsule body. Such a micro-perforated layer may have, with the aim of improving the adhesion thereof with the layer wherein it is incorporated and the barrier properties of the laminate as a whole, a surface coating such as aluminum oxide or silicon oxide;
fracturable paper film without barrier properties; extruded compostable biopolymer and possibly loaded with embrittlement additives or adhesive; fracturable regenerated cellulose film with barrier properties deriving from the depositing of chemical lacquers such as PVDC, PVOH, EVOH, aluminum oxide, silicon oxide and/or metallization; extruded compostable biopolymer loaded with additives which promote the peelability thereof and possibly others that increase the brittleness thereof; extruded polymer film or PLA-type, brittle cast or bubble, suitably micro-perforated and welded to the capsule body. Such a micro-perforated layer may have, with the aim of improving the adhesion thereof with the layer wherein it is incorporated and the barrier properties of the laminate as a whole, a surface coating such as aluminum oxide or silicon oxide;
filter paper or TNT non-woven fabric film, without barrier properties; extruded compostable biopolymer and possibly loaded with embrittlement additives or adhesive; fracturable regenerated cellulose film with barrier properties deriving from the depositing of chemical lacquers such as PVDC, PVOH, EVOH, aluminum oxide, silicon oxide and/or metallization; extruded compostable biopolymer loaded with additives which promote the peelability thereof and possibly others that increase the brittleness thereof; extruded polymer film or PLA-type, brittle cast or bubble, suitably micro-perforated and welded to the capsule body. Such a micro-perforated layer may have, with the aim of improving the adhesion thereof with the layer wherein it is incorporated and the barrier properties of the laminate as a whole, a surface coating such as aluminum oxide or silicon oxide;
laminate according to all of the preceding examples, wherein the most inner and loaded extruded polymer layer is substituted with an adhesive.

The examples of FIGS. 9 to 10 refer to non-compostable structures.

FIG. 9 shows a triple structure comprising:
outer side (that is to say the outer layer 10): film made of poly-ethylene terephthalate (PET) that has been weakened and metallized order to confer barrier properties thereto;
inner side: micro-perforated inner layer 20 made of poly-ethylene (PE) or poly-propylene (PP), at least partially immersed in the intermediate layer 30 made of extruded poly-ethylene (PE) or poly-propylene (PP), loaded with additives which promote the peelability thereof and possibly embrittlement additives.

FIG. 10 shows a triple overall structure comprising:
outer layer: further outer covering 40 composed of a film 41 made of weakened, non-metallized poly-ethylene terephthalate (PET) joined to an extruded polymer 42 that enables the permanent adhesion thereof to the outer aluminum layer 10;
inner side: micro-perforated inner layer 20 made of poly-ethylene (PE) or poly-propylene (PP), at least partially immersed in the intermediate layer 30 made of extruded poly-ethylene (PE) or poly-propylene (PP), loaded with additives which promote the peelability thereof and possibly embrittlement additives.

Further exemplary embodiments of non-compostable laminates described from the most outer layer to the most inner layer (welding):
film made of poly-ethylene terephthalate PET that has been weakened and metallized in order to confer barrier properties thereto; poly-ethylene PE or polypropylene PP or another compatible polymer, extruded and loaded with additives which promote the peelability thereof possibly with other embrittlement additives: poly-ethylene PE or poly-propylene PP sealing film, suitably mono-oriented or bi-oriented in order to make it more brittle micro-perforated. Such a micro-perforated layer may have, with the aim of improving the adhesion thereof with the layer wherein it is incorporated and the barrier properties of the laminate as a whole, a surface coating such as aluminum oxide or silicon oxide;
film made of poly-ethylene terephthalate PET that has been weakened and metallized in order to confer barrier properties thereto; poly-ethylene PE or polypropylene PP or another compatible polymer, extruded and loaded with additives which promote the peelability thereof possibly with other embrittlement additives: weldable appropriately micro-perforated poly-lactic acid PLA film. Such a micro-perforated layer may have, with the aim of improving the adhesion thereof with the layer wherein it is incorporated and the barrier properties of the laminate as a whole, a surface coating such as aluminum oxide or silicon oxide;
laminate according to the two preceding examples, wherein the outer layer is fracturable paper with possible barrier properties, or a regenerated cellulose film with barrier properties;
laminate having as the outer layer a weakened, non-metallized poly-ethylene terephthalate PET film, or a non-barrier paper film, or a regenerated cellulose non-barrier paper film; a first extruded poly-ethylene PE or poly-propylene PP based polymer layer or other compatible polymer (possibly loaded with embrittlement additives), or else an adhesive; aluminum film; second extruded poly-ethylene PE or poly-propylene PP based polymer layer or other compatible polymer (loaded with additives which promote the peelability thereof possibly with other embrittlement additives) ; poly-ethylene PE or polypropylene PP sealing film, suitably mono-oriented or bi-oriented in order to make it more brittle and micro-perforated. Such a micro-perforated layer may have, with the aim of improving the adhesion thereof with the layer wherein it is incorporated and the barrier properties of the laminate as a whole, a surface coating such as aluminum oxide or silicon oxide;
laminate having as the outer layer either a weakened, non-metallized poly-ethylene terephthalate PET film, or a non-barrier paper film, or a regenerated cellulose non-barrier paper film; a first extruded poly-ethylene PE or poly-propylene PP based polymer layer or other compatible polymer (possibly loaded with embrittlement additives), or adhesive; aluminum film; second extruded poly-ethylene PE or poly-propylene PP based polymer layer or other compatible polymer (loaded with additives which promote the peelability thereof possibly with other embrittlement additives); brittle and suitably micro-perforated weldable poly-lactic acid PLA film. Such a micro-perforated layer may have, with the aim of improving the adhesion thereof with the layer wherein it is incorporated and the barrier properties of the laminate as a whole, a surface coating such as aluminum oxide or silicon oxide;
laminate according to all of the preceding examples, wherein the most inner and loaded extruded polymer layer is substituted with an adhesive.

As described above, the inner layer 20 is a micro-perforated film, that is to say provided with a plurality of through holes 201. In an alternative entirely equivalent example, the inner layer 20 is a porous film, for example a filter paper or else a non-woven fabric film, and the intermediate layer 30 is partially peelable from said porous film.

The object of the present invention is also a capsule 1 for pressure-extractable beverages, comprising a cup-shaped body 2 closed by a sealing lid as described above.

Innovatively, a film for the lid of a capsule for the preparation of infusion or soluble beverages according to the present invention has zones of differing adhesion between the layers of the multilayer laminate that lead to an improved perforation opening.

Advantageously, by virtue of the absence of adhesives, there are no risks to the beverage of contamination.

Advantageously, the film may be manufactured as completely compostable.

Advantageously, furthermore, by virtue of the fact that the adhesive is substituted by a biopolymer, advantages are gained during the packaging step when the lid tapers under the pressure of the sealing bars during the welding between the lid and capsule body.

The laminated multilayer film according to the present invention is devoid of known structural defects, and has many advantages:
the problem of potential contamination is resolved by the presence of the extruded polymer matrix which, as with the possible embrittlement additives and those that confer peelability, is ideal for coming into contact with foodstuffs;
the micro-holes of the micro-perforated layer do not widen and do not risk being clogging with powdered foodstuff product;
the micro-perforated layer is not impregnated with the beverage and does not compromise the correct delivery of the beverage;
the micro-holes are uniformly distributed within the micro-perforations ensuring a uniform welding zone with the edge of the capsule body leading to uniform welding profiles;
the laminate, in the entirety thereof, has barrier properties against gases, vapors, oils, fats and aromas. Such barrier properties derive from the fact that one or more of the films that comprise these barrier properties exhibit such properties following on from: special physical treatments that do not imply the use of chemical lacquers, coating and/or metallization; or chemical treatments involving the use of chemical lacquers, coating and/or metallization.
the outer layer 10, of a brittle material, has the object of tearing itself against appropriate piercing elements that are found within the dispensing machine thereby favoring the delivery of the beverage itself.
the laminate, in the entirety thereof, as with the capsule in the entirety thereof, may be manufactured both as a non-compostable version and a compostable version according to the usual regulations in force. In fact, both any embrittlement and non-compostable additives (for example, talc) and any additional non-compostable layers, are found to be in suitable percentages by weight for the whole system to be considered compostable.

It is understood that a person skilled in the art could make modifications to the capsule for the preparation of infusion or soluble beverages described above, all of which are contained within the scope of protection as defined by the following claims.

What is claimed is

1-16. (canceled)

17. A multilayer film for sealing a capsule for making beverages, comprising:
an outer layer with gas and/or vapor barrier properties;
an inner layer intended to come into contact with the capsule to be sealed, the inner layer being a micro-perforated film provided with a plurality of micro-holes; and
an intermediate layer between the outer layer and the inner layer;
wherein the intermediate layer is partially peelable from the inner layer within a low adhesion delamination zone between the inner layer and the intermediate layer,
wherein an adhesion in the low adhesion delamination zone has values between 0.25 and 5.00N/15 mm,
wherein the intermediate layer is permanently joined to the inner layer at least in a high adhesion zone, and
wherein the adhesion in the high adhesion zone is greater than 5.00 N/15 mm.

18. The multilayer film of claim 17, wherein the outer layer is a brittle paper film with barrier properties deriving solely from a dense adhesion of paper microfibers, or is a brittle regenerated cellulose film with barrier properties provided, at choice, from: polyvinylidene chloride (PVDC) lacquer-based outer coatings, polyvinyl alcohol (PVOH) lacquer, silicon or aluminum oxides, and metallic aluminum-based metallization.

19. The multilayer film of claim 17, wherein the outer layer is a weakened and metallized polyethylene terephthalate film to confer the barrier properties thereto, or an aluminum film.

20. The multilayer film of claim 17, wherein a diameter of the micro-holes is between 0.1 mm and 1.0 mm.

21. The multilayer film of claim 20, wherein the diameter of the micro-holes is between 0.3 mm and 0.8 mm.

22. The multilayer film of claim 17, wherein a density of the micro-holes is between 5 and 25 micro-holes/cm².

23. The multilayer film of claim 22, wherein the density of the micro-holes is between 8 and 20 micro-holes/cm².

24. The multilayer film of claim 17, wherein the inner layer is made of a compostable material, possibly provided with an aluminum oxide or silicon oxide surface coating.

25. The multilayer film of claim 17, wherein the intermediate layer is made of a polymer material, hot cast onto the inner layer so as to at least partially fill the micro-holes.

26. The multilayer film of claim 17, wherein the intermediate layer is a compostable biopolymer extruded and loaded with additives selected from the group consisting of: poly-butylene-succinate (PBS), poly-lactic acid (PLA), poly-butylene-adipate-terephthalate (PBAT) or compounds/blends thereof, and any other polymers of plant origin.

27. The multilayer film of claim 17, wherein the intermediate layer is an adhesive, said adhesive being present only in some zones or evenly but with different weights from zone to zone.

28. A capsule for making beverages, comprising a cup-shaped body, which defines an internal volume wherein there is at least one foodstuff substance to be infused or dissolved, closed by a lid made from a multilayer film comprising:
an outer layer with gas and/or vapor barrier properties;
an inner layer intended to come into contact with the capsule to be sealed, the inner layer being a micro-perforated film provided with a plurality of micro-holes; and
an intermediate layer between the outer layer and the inner layer;
wherein the intermediate layer is partially peelable from the inner layer within a low adhesion delamination zone between the inner layer and the intermediate layer,
wherein an adhesion in the low adhesion delamination zone has values between 0.25 and 5.00 N/15 mm,
wherein the intermediate layer is permanently joined to the inner layer at least in a high adhesion zone, and
wherein the adhesion in the high adhesion zone is greater than 5.00 N/15mm,
wherein said lid has:
a high level of adhesion between the inner layer and the intermediate layer at least at an outer periphery corresponding to a welding zone with an edge of the cup-shaped body, and
a low level of adhesion between the inner layer and the intermediate layer in a central zone.

29. The capsule of claim 28, wherein, in the central zone, the lid has
at least one point at a high level of adhesion, or
a grid with a high level of adhesion that defines a plurality of low adhesion level zones between the inner layer and the intermediate layer.

30. The capsule of claim 29, wherein, in the central zone, the lid has a plurality of points at a high level of adhesion.

31. A method of extracting the capsule of claim 28 by an extraction machine that injects a pressurized liquid into the capsule and is provided with piercing elements, wherein pressure of the pressurized liquid within the cup-shaped body leads to a delamination between the inner layer and the intermediate layer only in low adhesion level zones, and wherein, upon delamination, a thrust chamber is formed between the inner layer and the intermediate layer, the thrust chamber containing the pressurized liquid which pushes, to an exterior of the capsule, at least the outer layer to tear against the piercing elements of the extraction machine.

32. A method of extracting the capsule of claim 28 by an extraction machine that injects a pressurized liquid into the capsule and that is provided with piercing elements, wherein pressure of an outgassing gas of the foodstuff substance contained within the cup-shaped body leads to a delamination between the inner layer and the intermediate layer only in low adhesion level zones, and wherein, upon delamination, a thrust chamber is formed between the inner layer and the intermediate layer, the thrust chamber containing the pressurized liquid that pushes outward from the capsule at least the outer layer to tear against the piercing elements of the extraction machine.
